(19) United States
(12) Patent Application Publication
(10) Pub. No.: US 2011/0154723 A1
(43) Pub. Date: Jun. 30, 2011

(54) PROCESS FOR REMOVING STERYL GLYCOSIDES FROM BIODIESEL

(75) Inventors: Ulrich Sohling, Freising (DE); Friedrich Ruf, Tiefenbach-Ast (DE); Jose Antonio Ortiz Niembro, Pue (MX); Rosalina Condemarin Vargas, Lima (PE); Jorge Bello, Pue. (MX)

(73) Assignee: SÜD-CHEMIE AG, MUNICH (DE)

(21) Appl. No.: 12/990,596

(22) PCT Filed: Apr. 30, 2008
(86) PCT No.: PCT/EP2008/003521

§ 371 Date: Mar. 11, 2011

(51) Int. Cl. C10L 1/00

(52) U.S. Cl. 44/307

(57) ABSTRACT

A method for purifying biodiesel, wherein a crude biodiesel is provided which contains at least one glycoside, and the crude biodiesel is reacted with an adsorbent which contains at least one smectite-silica gel mixed phase. The smectite-silica gel mixed phase has at least the following physical parameters: a specific surface area of more than 120 m2/g; a total pore volume of more than 0.35 ml/g; and a silicon content, calculated as SiO2, of at least 60 wt-%. A purified biodiesel is separated off from the adsorbent.

### CROSS REFERENCE TO RELATED APPLICATIONS

This is a National Phase application of PCT application number PCT/EP2008/003521, filed Apr. 30, 2008, the content of which is being incorporated herein by reference.

### FIELD OF THE INVENTION

The invention relates to a method for purifying biodiesel, biodiesel precursors, vegetable or animal fats and their mixtures.

### BACKGROUND OF THE INVENTION

Because of the limited occurrence of fossil raw materials and repeated increases in energy prices, fuels based on renewable raw materials are attracting ever greater interest. In particular, biodiesel is currently already being added to the diesel fuels available on the market in Europe. Additionally, vegetable or animal fats can also be used as fuels or serve as starting material for the production of biodiesel.

Biodiesel is produced by alcoholysis of triglycerides, wherein one mol triglyceride is reacted with three mols alcohol to one mol glycerol and three mols of the corresponding fatty acid ester. The reaction comprises three reversible reactions, wherein the triglyceride is transformed stepwise into a diglyceride, a monoglyceride and finally into glycerol. In each of the steps one mol alcohol is used and one mol of fatty acid ester released. Methanol is used as alcohol in most industrial processes.

However, biodiesel which contains ethyl or propyl fatty acid esters is also offered for sale.

The transesterification can be carried out as a one-stage process. It is, however, also possible to carry out the transesterification in several stages. In each step, only some of the required methanol is added and the glycerol phase separated off after each step. Additionally, the alcoholysis can be carried out under both acid and basic catalysis.

In most industrial processes the alcoholysis of the triglycerides is carried out under homogeneous alkaline catalysis. The alkoxide ion acting as catalyst is produced for example by dissolving an alkali alcoholate in the alcohol or reacting the pure alkali metal with the alcohol. In methanolysis, a corresponding alkali hydroxide can also be dissolved in the methanol. Because a phase separation due to the resulting glycerol occurs relatively rapidly during the alcoholysis of triglycerides, the great majority of the alkaline catalyst is removed relatively quickly from the reaction mixture. The resulting fatty acid esters therefore scarcely come into contact with the catalyst, with the result that the risk of saponification is small. Relative to the oil used, the catalyst is used mostly in a quantity of 0.5 to 1 wt.-%. For details of biodiesel production, reference is made to the monograph by M. Mittelbach, C. Remschmidt, “Biodiesel; The comprehensive Handbook”, Graz, 2004; ISBN 3-200-00249-2.

The triglycerides used as starting materials for biodiesel production can be obtained for example from vegetable or animal fat. Of the vegetable raw materials, four starting materials are principally used in the worldwide production of biodiesel, namely rapeseed oil, sunflower oil, soya bean oil and palm oil. Further starting materials which are commercially significant are animal fats, such as beef tallow, as well as used frying fats.

In order to remove soaps produced during biodiesel production, as well as residual methanol, glycerol, mono- and diglycerides, from the biodiesel, in most cases a water wash is carried out after the transesterification. If the crude biodiesel contains large quantities of soaps a stable emulsion can form, which makes the separation of the fatty acid esters much more difficult.

Constantly increasing demands in respect of the product properties of fuels based on renewable raw materials are being made, both by consumers and by the authorities. In order to ensure a defined combustion of the biodiesel, in Germany for example limit values have been set for minor components in biodiesel. According to DIN standard DIN EN 14214, a maximum monoglycerides content of 0.8 wt.-%, a maximum free glycerine content of 0.2 wt.-%, a maximum diglycerides content of 0.2 wt.-%, and similarly a maximum triglycerides content of 0.2 wt.-% have been set.

As biodiesel is produced from natural raw materials, the concentrations of impurities as well as their composition fluctuate within wide limits. This can lead to difficulties in the production of the biodiesel. If the biodiesel is cooled to room temperature after production or also when stored for a longer period of time, for example small quantities of a fine precipitate often still form, which can then lead for example to the clogging of filters. Glycosides, and here in particular sterylglycosides, have been identified as a substance class which leads to the formation of precipitates in biodiesel which has been produced by transesterification from vegetable oils. Sterines are steroids derived from cholesterol which carry only a hydroxy group at C-3, but no functional group. They mostly have a double bond in 5/6 position, less frequently also in 7/8 or 8/9 position. Formally they are alcohols and are therefore also frequently called sterols. Naturally occurring sterylglycosides often also comprise, in addition to the glycosidically bound sterine, a fatty acid with which the primary hydroxy group of the sugar is acylated. As a result they are very well soluble in vegetable or animal fats. It is assumed that, during the alcoholysis of the triglycerides, the acyl group at the primary hydroxy group of the sterylglycoside is also split, wherein a non-acylated sterylglycoside is obtained. These non-acylated sterylglycosides are almost insoluble in biodiesel. They are therefore present as very fine suspended particles which for example can act as nuclei for the crystallization of other compounds. Difficulties which are caused for example by monoglycerides still present in the biodiesel can therefore increase. Non-acylated sterylglycosides in very small concentrations can already bring about the precipitation of solid aggregates from biodiesel. Concentrations in the double-digit ppm range can already lead at room temperature to clouding in biodiesel. Non-acylated sterylglycosides have a very high melting point of approximately 240° C. Clouding or precipitates which are caused by non-acylated sterylglycosides can therefore not easily be dissolved by heating the biodiesel to a higher temperature. If deposits are thus already present on a filter, this becomes completely clogged relatively quickly in the presence of non-acylated sterylglycosides in the biodiesel.

After the production process the biodiesel is subjected to a final test. If it is established that the filter-clogging test is not passed because the biodiesel finished in itself still contains very small quantities of non-acylated sterylglycoside, this biodiesel cannot be approved.

A method known from the state of the art for separating ingredients, such as for example sterylglycosides, from biodiesel, is based on the cooling of crude biodiesel to low temperatures and then filtering it. This method is, however, extremely expensive to carry out.

WO 2007/076163 A describes a method for treating biodiesel with adsorbents and the like to remove steryl glycosides.

### DESCRIPTION OF THE INVENTION

An object of the invention, therefore, was to provide a method for purifying biodiesel, with which very small quantities of glycosides, in particular sterylglycosides, can also be removed from the biodiesel. It should be possible to carry out the method very easily at favourable cost, with the result that it can also be used for the final purification of biodiesel which is already of high quality.

This object is achieved by a method with the features of claim 1. Preferred embodiments of the method according to aspects of the invention are a subject of the dependent subordinate claims.

According to aspects of the invention it was found that, by using a special adsorbent which contains a special smectite-silica gel mixed phase, very small quantities of glycosides, in particular sterylglycosides, can also be removed from biodiesel. Such smectite-silica gel mixed phases are accessible from natural sources and can therefore be produced easily and at favourable cost. Also, only a relatively small quantity of the adsorbent is required as such to remove the glycosides, in particular non-acylated sterylglycosides, still present in the biodiesel. The method can therefore be used very well for post-purification of biodiesel. Such an additional purification stage can then be used if, after production of the biodiesel, the specification for, say, non-acylated sterylglycoside is not met and a post-purification is required. The method according to aspects of the invention can, however, also be used routinely for example as final purification stage for the further refinement of the biodiesel.

According to aspects of the invention a method for purifying biodiesel is therefore proposed, wherein
a crude biodiesel is provided which contains at least one glycoside;
the crude biodiesel is reacted with an adsorbent which contains at least one smectite-silica gel mixed phase, wherein the smectite-silica gel mixed phase has at least the following physical parameters:
   a specific surface area of more than 120 m²/g,
   a total pore volume of more than 0.35 ml/g;
   a silicon content, calculated as SiO₂, of at least 60 wt-%; and
a purified biodiesel is separated off from the adsorbent.

Firstly, a crude biodiesel is provided with the method according to aspects of the invention.

By “biodiesel” is meant a mixture of fatty acid alkyl esters such as customarily obtained in the alcoholysis of natural fats and oils. The alcoholysis may have been carried out under acid and also under alkaline catalysis. Oils and fats such as are customarily used in the production of biodiesel can be used as natural fats and oils. Where reference is made below to “fats”, this can thus also include oils. Similarly, fats are also included if reference is made to oils. By fats and oils are generally meant triglycerides of long-chained fatty acids. The fatty acids preferably comprise more than 10 carbon atoms and preferably comprise 15 to 40 carbon atoms. The alkyl chain of the fatty acids is preferably straight-chained. It may be completely hydrogenated or also comprise one or more double bonds. Suitable starting materials are vegetable fats, such as rapeseed oil, sunflower oil, soya bean oil or palm oil. However, other vegetable fats can be used, such as jatropha oil or oils that have been produced from algae. These oils are not suitable for human consumption. Moreover agricultural area which is also suitable for food production is not used for the production of these plants. The jatropha nut can for example be cultivated on very infertile soils which are not suitable for cereal production. Furthermore, animal fats, such as beef tallow, can also be used. Used fats such as frying fats can also be used. Both oils and fats which go back to only one source can be used. But it is also possible to use mixtures of fats and oils. Before alcoholysis, the fats and oils are preferably purified in known manner and for example degummed and/or deodorized. According to a preferred embodiment fats or oils with a lecithin content of less than 10 wt.-%, in particular less than 5 wt.-%, further preferably less than 10 ppm, in particular less than 5 ppm, are used for the alcoholysis.

These fats and oils are split into glycerol and fatty acids in customary manner by alcoholysis. The alcoholysis takes place preferably under alkaline catalysis. Alcohols customary in the production of biodiesel such as methanol, ethanol or propanol, can be used as alcohols. The use of other alcohols is likewise possible.

Within the framework of the present invention the term “biodiesel” can also mean in particular any mixture of fatty acid alkyl esters. The alkyl residue of the fatty acid alkyl ester can for example be straight-chained or branched and comprise 1 to 28 carbon atoms. In particular the fatty acid alkyl ester can for example be a methyl, ethyl, propyl, butyl, pentyl, hexyl ester of a fatty acid. Preferably the mixture of fatty acid alkyl esters contains at least 70 wt.-% fatty-acid alkyl ester, preferably at least 85 wt.-%, preferably at least 95 wt.-%, in particular at least 98 wt.-%, in each case relative to the total weight of the organic constituents of the mixture.

Mixtures described as biodiesel can contain any quantities of mono-, di-, and/or triglycerides. Preferably, biodiesel can have a limited mono-, di-, and/or triglycerides content. For example the biodiesel can contain at most 2 wt.-%, preferably at most 0.8 wt.-% monoglycerides, at most 2 wt.-%, preferably at most 0.2 wt.-% diglycerides, and/or at most 2 wt.-%, preferably at most 0.2 wt.-% triglycerides, determined according to DIN standard DIN EN 14214.

The mixture obtained during the alcoholysis of fats and oils is worked up in customary manner. Thus for example the glycerol phase can be separated off from the crude biodiesel or the crude biodiesel also washed once or more times with water. It is, however, also possible to firstly purify the crude biodiesel obtained during alcoholysis with the help of an adsorbent.

By a “crude biodiesel” is meant as such any biodiesel which has a higher glycoside content than a biodiesel which has been purified with the method according to aspects of the invention. Accordingly, by a “purified biodiesel” is meant a biodiesel which has a lower glycoside content than the crude biodiesel.

A crude biodiesel can thus be a biodiesel such as is obtained immediately after alcoholysis of the fats and/or oils, for example immediately after separating off the glycerol phase. A crude biodiesel can however also be a biodiesel which has already passed through purification stages after alcoholysis, but still has too high a glycoside content, in particular too high a content of sterylglycosides, with the result that it does not meet a specific specification and must be subjected to post-purification.

According to aspects of the invention a special adsorbent is then added to the crude biodiesel.

A smectite-silica gel mixed phase which is characterized by a very high specific surface area or more than 120 m²/g, preferably more than 150 m²/g is used as adsorbent. The smectite-silica gel mixed phase can have a specific surface area of up to 300 m²/g, preferably up to 280 m²/g. Furthermore, the smectite-silica gel mixed phase used as adsorbent is characterized by a very high total pore volume of more than 0.35 ml/g. The adsorbent used in the method according to aspects of the invention has an unusually high proportion of a silica gel phase. The adsorbent used in the method according to aspects of the invention therefore has a high silicon content, calculated as SiO₂, of at least 60 wt.-%, preferably more than 63 wt.-%, in particular preferably more than 70 wt.-%. According to an embodiment of the method the silicon content of the smectite-silica gel mixed phase is less than 85 wt.-%. According to a further embodiment the silicon content of the adsorbent, calculated as SiO₂, is less than 75 wt.-%.

Surprisingly it was found that small quantities of glycosides, in particular sterylglycosides, can also be removed from the crude biodiesel with the smectite-silica gel mixed phase used in the method according to aspects of the invention. The inventors' starting point is that, with the method according to aspects of the invention, the disruptive glycosides are bound by the adsorbent, thus the adsorbent does not act merely as filter medium. In particular if they are present in very low concentration in the biodiesel, for example in the double-digit ppm range, sterylglycosides form an extremely finely dispersed precipitate which can be retained only with difficulty by a filter medium. With the method according to aspects of the invention a removal in particular of sterylglycosides is also achieved if these are contained in the biodiesel in small quantities and only a small quantity of the adsorbent is used in the form of a relatively coarse-grained granular material for removal.

The adsorbent used in the method according to aspects of the invention has a special structure which differs clearly from the structure of clays such as bentonites. Unlike these clays, which have a relatively ordered sheet structure and therefore can for example swell, the smectite-silica gel mixed phase used as adsorbent has a largely amorphous structure. The inventors' starting point is that the amorphous phase is substantially formed by SiO₂.

Minute particles of a sheet silicate are then fixed in strongly delaminated form in this relatively rigid SiO₂ matrix.

The smectite-silica gel mixed phase used in the method according to aspects of the invention thus represents an intimate mixing of a smectitic clay and an amorphous silicon dioxide phase. It thus does not have an ordered sheet structure such as is typical in itself of clay minerals such as bentonite or attapulgite. Macroscopically the smectite-silica gel mixed phase has an homogeneous structure. Thus domains which are formed by a gel-like SiO₂ or by a sheet silicate using optical microscopic methods for example cannot be recognized. The presence of a smectitic phase can also be demonstrated for example by the adsorption of methylene blue. The method is described in detail in the examples. On the other hand, the smectite-silica gel mixed phase used in the method according to aspects of the invention is X-ray amorphous and does not show reflexes typical of sheet silicates.

The inventors' starting point is that the smectite-silica gel mixed phase used in the method according to aspects of the invention comprises a continuous phase which is formed from silica gel. Very small platelets of a sheet silicate are inserted homogeneously distributed throughout this amorphous phase.

Thus the structure of the smectite-silica gel mixed phase used in the method according to aspects of the invention differs substantially from that of clays such as are for example used as natural bleaching earths for refining oils.

These are sheet silicates and do not comprise any large proportions of an amorphous phase formed from SiO₂. The smectite-silica gel mixed phase used in the method according to aspects of the invention contains platelets formed from a sheet silicate which are distributed homogeneously in the structure. Thus the structure also differs clearly from a structure such as for example highly-active bleaching earths have. These are obtained by extraction from sheet silicates with strong acids. The sheet structure of the sheet silicate used as starting material is dissolved starting from the edges. Such highly-active bleaching earths therefore comprise a nucleus formed from a sheet silicate which is enclosed by an envelope of amorphous silicon dioxide and thus have an inhomogeneous structure.

The smectite-silica gel mixed phase used in the method according to aspects of the invention thus represents a new class of clay minerals, the structure and properties of which differ clearly from those of the clay minerals used thus far. The materials can be mined from natural sources and can therefore be provided simply and at relatively low cost.

The smectite-silica gel mixed phase used as adsorbent in the method according to aspects of the invention has a very high specific surface area of preferably 180 to 300 m²/g, particularly preferably 185 to 280 m²/g, in particular preferably 190 to 250 m²/g. The specific surface area is determined according to the BET method. The adsorbent used in the method according to aspects of the invention also has a high pore volume of preferably more than 0.5, in particular preferably more than 0.55 ml/g, in particular preferably more than 0.60 ml/g. According to an embodiment of the method the adsorbent has a pore volume of less than 1.2 ml/g. According to a further embodiment of the method the pore volume is less than 1.0 ml/g and according to a further embodiment less than 0.9 ml/g.

The smectite-silica gel mixed phase used as adsorbent in the method according to aspects of the invention comprises an amorphous phase, consisting of SiO₂, which forms a relatively rigid matrix. This matrix has large pores through which the crude biodiesel can easily penetrate the adsorbent. Small platelets of sheet silicates which act as adsorbent are inserted inside the matrix. Whereas only the edge regions of the particles have been used to adsorb disruptive materials with the clays used thus far, a substantially higher proportion of the particle volume can be used with the smectite-silica gel mixed phase used in the method according to aspects of the invention. The inventors assume that the glycosides, in particular sterylglycosides, present as fine precipitate or dissolved in the crude biodiesel, are adsorbed at the surface of the strongly delaminated structure of the smectite phase contained in the smectite-silica gel mixed phase. It is known in itself that clays, thus sheet silicates, adsorb alcohols and polyols, and can become embedded in interlayers when the distance between sheets increases. However, as the glycosides, in particular sterylglycosides, represent relatively large molecules, the penetration of these glycosides into the sheet structure of a clay, such as bentonite, is made difficult. Also, the sterylglycosides are present in the form of a very fine solid, with the result that it cannot in itself be expected that sterylglycosides are already adsorbed by small quantities of clays. With the smectite-silica gel mixed phase used in the method according to aspects of the invention the smectite phase is present in strongly delaminated and therefore very finely distributed form. Because of the strongly porous structure of the silica gel phase the crude biodiesel is conducted to the finely-distributed smectite phase, with the result that glycosides, in particular sterylglycosides, that are disruptive can be adsorbed there. The smectite-silica gel mixed phase used in the method according to aspects of the invention scarcely swells, wherein, however, because of the fine distribution of the smectite phase, a large number of binding sites is made available for disruptive glycosides.

The smectite-silica gel mixed phase used as adsorbent can be introduced in any form into the crude biodiesel to be purified. Thus it is for example possible to stir the ground adsorbent into the biodiesel.

If the adsorbent is introduced into, and suspended in, the crude biodiesel in the form of a powder or granular material, with this embodiment of the method according to aspects of the invention, during purification the crude biodiesel is preferably moved, for example with the help of a stirrer, with the result that the adsorbent is intimately mixed with the biodiesel in order to adsorb disruptive glycosides.

The quantity of adsorbent added to the biodiesel depends on the quantity of glycoside contained in the crude biodiesel. If a crude biodiesel, such as is obtained immediately after the alcoholysis, is used it is advisable to use substantial quantities of the adsorbent. If, according to a preferred embodiment, the method according to aspects of the invention is used for post-purification of a crude biodiesel which merely still contains small impurities due to glycosides, the quantity of added adsorbent can be kept correspondingly small.

The treatment time during which the crude biodiesel is brought into contact with the adsorbent depends in itself on the relative quantities of crude biodiesel and adsorbent as well as on the quantity of glycosides, in particular sterylglycosides, contained in the crude biodiesel. Because of its less strongly open-pored structure the adsorbent used in the method according to aspects of the invention is, however, characterized by relatively fast kinetics. Preferably the chosen contact time between crude biodiesel and adsorbent is longer than 5 minutes, preferably between 10 and 120 minutes, particularly preferably between 15 and 60 minutes, and in particular preferably between 5 and 30 minutes.

Preferably, the method according to aspects of the invention is carried out at room temperature or particularly preferably at temperatures above room temperature. During treatment with the adsorbent, the crude biodiesel therefore preferably has a temperature in the range of from 15 to 100° C., particularly preferably 30 to 90° C. In particular, during treatment with the adsorbent the crude biodiesel preferably has a temperature in the range of from 40 to 80° C. Preferably the purification, in particular the final purification of the biodiesel, is carried out at a temperature above room temperature. Experience shows that the solubility of the sterylglycosides in the biodiesel is better at these temperatures. Sterylglycosides which are precipitated out of the biodiesel after cooling can be dissolved again by heating the crude biodiesel. Operation at higher temperatures also ensures that the sterylglycosides are depleted by adsorption at the adsorbent, and that not just a filtration takes place. This is particularly important if, to purify the crude biodiesel, the adsorbent is provided in the form of a column packing. A formation of precipitates would clog the column and also make a regeneration of a column difficult.

After treatment the adsorbent is again separated from the biodiesel. Customary methods can be used for this. For example, the adsorbent can be left to sedimentate and the supernatant purified biodiesel decanted off. It is, however, also possible to separate off the adsorbent from the purified biodiesel for example by filtration.

As already explained above, the smectite-silica gel mixed phase used in the method according to aspects of the invention is characterized by a particular structure which comprises an amorphous matrix, formed from SiO₂, which is relatively rigid and into which very small clay particles are homogeneously inserted.

Preferably the smectite-silica gel mixed phase used as adsorbent in the method according to aspects of the invention has an amorphous phase content of at least 10 wt.-%, particularly preferably at least 20 wt.-% and in particular preferably at least 30 wt.-%. According to an embodiment of the method according to aspects of the invention the proportion of the amorphous phase in the smectite-silica gel mixed phase is less than 90 wt.-%, according to a further embodiment less than 80 wt.-%. In addition to the amorphous phase substantially formed from SiO₂ the smectite-silica gel mixed phase used in the method according to aspects of the invention comprises a smectite phase. The proportion of the smectite phase in the adsorbent used in the method according to aspects of the invention is preferably less than 60 wt.-%, particularly preferably less than 50 wt.-%, in particular preferably less than 40 wt.-%. According to an embodiment of the invention the proportion of the smectite phase is at least 10 wt.-%, according to a further embodiment at least 20 wt.-%. The ratio of smectite phase to amorphous phase is preferably within a range of from 2 to 0.5, particularly preferably within a range of from 1.2 to 0.8.

As the adsorbent used in the method according to aspects of the invention is preferably mined from natural sources, the adsorbent can also contain further minor minerals in addition to the smectite-silica gel mixed phase. The proportion of minor minerals in the adsorbent preferably lies in the range of from 0.5 to 40 wt.-%, particularly preferably 1 to 30 wt.-%, in particular preferably 3 to 20 wt.-%. Examples of minor minerals are quartz, cristobalite, feldspar and calcite. In addition to the named minor minerals, the adsorbent can however also contain other minor minerals.

The structure of the smectite-silica gel mixed phase used as adsorbent and the proportion of the amorphous phase or of the smectite phase can be ascertained using various methods.

As already explained, the smectite-silica gel mixed phase comprises an amorphous phase formed from SiO₂. Figuratively speaking, this amorphous phase dilutes the smectite phase and thus leads, depending on the proportion of the smectite phase, to a reduction in the signal-to-noise ratio for a typical reflex of a smectitic mineral. Thus for example reflexes of montmorillonite are created at small angles by the periodically recurring distance between the sheets of the montmorillonite structure. Also, with the smectite-silica gel mixed phase used in the method according to aspects of the invention, the smectite particles are strongly delaminated in the SiO₂ matrix, which leads to a strong broadening of the corresponding reflex in the diffractogram.

In an X-ray diffractogram of the smectite-silica gel mixed phase used in the method according to aspects of the invention the reflexes scarcely stand out above the noise. With the reflexes created by the smectite-silica gel mixed phase, the signal-to-noise ratio is close to 1 and according to an embodiment lies in the range of from 1 to 1.2. Sharp reflexes can, however, also occur in the diffractogram. However, these are attributable to impurities caused by minor minerals, such as quartz. The reflexes created by such minor minerals are not taken into account when calculating the signal-to-noise ratio.

The smectite-silica gel mixed phase used with the method according to aspects of the invention shows almost no 001 reflex, which is characteristic of the sheet distance in the crystal structure of bentonite. The signal-to-noise ratio of the 001 reflex of the smectitic particles is preferably less than 1.2, and lies particularly preferably in a range of from 1.0 to 1.1.

The proportion of the amorphous silicon dioxide phase and of the smectitic phase can be determined by quantitative X-ray diffractometry. The details of the method are described for example in “Handbook of Clay Science”, F. Bergaya, B. K. G. Therry, G. Nagaly (eds.), Elsevier, Oxford, Amsterdam, 2006, Chap. 12.1: I. Srodon, “Identification and Quantitative Analysis of Clay Minerals; X-Ray Diffraction and the Identification and Analysis of Clay Minerals”, D. M. Moora, R. C. Raynolds, Oxford University Press, New York, 1997, p. 765 et seq.

Quantitative X-ray diffractometry is based on Rietveld's algorithm. This algorithm was originally developed by H. M. Rietveld for the refining of crystal structures. This method is applied as standard method in mineralogy. An example from the cement industry is the quantitative analysis of mineral phases in unknown mineral samples.

Rietveld's refining algorithm is based on a matching of a simulated diffractogram to a measured diffractogram.

Firstly, the mineral phases are determined by allocation of the reflexes occurring in the diffractogram. On the basis of the detected minerals, a diffractogram is then calculated on the basis of the crystal structure of the minerals detected in the sample. In the following steps the parameters of the model are adapted, with the result that a good agreement is achieved between the calculated and measured diffractogram. For example, the least error squares method is used for this. The details of the method are described for example in: R. Young: “The Rietveld Method”, Oxford University Press, 1995. With the Rietveld method, reliable statements can be made based on the diffractogram even where there are strongly overlapping reflexes.

Reference is made for example to D. K. McCarthy “Quantitative Mineral Analysis of Clay-bearing Mixtures”, in: “The Reynolds Cup” Contest. IUCr CPD Newsletter 27, 2002, 12-16 concerning the application of this method to the analysis of mineral samples.

In practical application the quantitative determination of the different minerals in unknown samples can be carried out with the help of a commercially available software programme. Such a software programme is available, for example, under the name “Seifert AutoQuan” from Seifert/GE Inspection Technologies, Ahrensburg, Germany.

The smectite-silica gel mixed phase used as adsorbent in the method according to aspects of the invention scarcely swells in water. The adsorbent can therefore be easily separated from the purified biodiesel. Preferably, after swelling in water for 1 hour, the adsorbent has a sediment volume of less than 15 ml/2 g, particularly preferably of less than 10 ml/2 g and in particular preferably of less than 7 ml/2 g auf.

The smectite-silica gel mixed phase used as adsorbent preferably has a cation-exchange capacity of at least 40 meq/100 g, particularly preferably of more than 45 meq/100 g, and is chosen in particular preferably in a range of from 44 to 70 meq/100 g. The high ion-exchange capacity distinguishes the smectite-silica gel mixed phase used in the method according to aspects of the invention for example from highly-active bleaching earths which are obtained by extraction from sheet silicates with strong acids at boiling heat. These are characterized by a very low cation-ion exchange capacity which customarily lies below 40 meq/100 g and in most cases is less than 30 meq/100 g. The smectite-silica gel mixed phase used in the method according to aspects of the invention therefore differs dramatically from such highly-active bleaching earths.

The adsorbent used in the method according to aspects of the invention also differs in characterizing manner from the so-called surface-modified bleaching earths. These surface-modified bleaching earths are obtained by covering a sheet silicate with an acid, for example by spraying a clay mineral, i.e. a sheet silicate with an acid. These surface-modified bleaching earths display a similar cation-exchange capacity to the adsorbent used in the method according to aspects of the invention. However, the surface-modified bleaching earths have a clearly lower pore volume, which distinguishes them in characterizing manner from the adsorbent used in the method according to aspects of the invention. When using surface-modified bleaching earths the crude biodiesel cannot easily reach the inner sections of the adsorbent particles, as these clay minerals swell and therefore further access of the crude biodiesel to the interlayers of the sheet silicate is blocked. The adsorption rate is therefore low for such surface-activated bleaching earths.

The smectite-silica gel mixed phase used in the method according to aspects of the invention is characterized in particular by a high SiO₂ content. In addition to silicon, however, the mixed phase can also contain other metals or metal oxides. The percentage proportions given below relate to a smectite-silica gel mixed phase which has been dried to constant weight at 105° C.

The smectite-silica gel mixed phase preferably has a low aluminium content. The aluminium content, calculated as Al₂O₃, is preferably less than 15 wt.-%, particularly preferably less than 10 wt.-%. According to an embodiment the aluminium content, calculated as Al₂O₃, is more than 2 wt.-%. According to a further embodiment the aluminium content is more than 4 wt.-%.

According to a further embodiment of the method according to aspects of the invention the smectite-silica gel mixed phase used as adsorbent contains magnesium in a quantity, calculated as MgO, of less than 7 wt.-%, particularly preferably of less than 6 wt.-%, in particular preferably of less than 5 wt.-%. According to an embodiment of the method according to aspects of the invention the adsorbent contains at least 0.5 wt.-% magnesium, particularly preferably at least 1.0 wt.-%, each calculated as MgO. According to a further embodiment the adsorbent contains at least 2 wt.-% MgO.

According to a further embodiment the adsorbent can also comprise iron. The quantity of iron, calculated as Fe₂O₃, contained in the smectite-silica gel mixed phase is preferably less than 8 wt.-%. According to a further embodiment the iron content of the smectite-silica gel mixed phase is less than 6 wt.-% and according to a further embodiment less than 5 wt.-%. According to a further embodiment of the invention the adsorbent contains iron, calculated as Fe₂O₃, in a quantity of at least 1 wt.-%, and according to a further embodiment in a quantity of at least 2 wt.-%.

The inventors' starting point is that the distribution of the pore radii affects the activity of the adsorbent. According to a first embodiment of the method according to aspects of the invention preferably at least 60%, particularly preferably 65 to 70% of the total pore volume of the adsorbent is accounted for by pores which have a pore diameter of at least 140 Å. Preferably at least 40%, particularly preferably at least 50%, in particular preferably 55 to 60% of the total pore volume is accounted for by pores which have a pore diameter of less than 250 Å and preferably at least 20%, particularly preferably at least 25% of the total pore volume is accounted for by pores which have a pore diameter of 140 to 250 Å. Preferably less than 20% of the total pore volume, particularly preferably less than 15%, in particular preferably 10 to 14% of the total pore volume is accounted for by pores which have a pore diameter of >800 Å.

According to a further preferred embodiment at least 20%, preferably at least 25%, particularly preferably at least 30% and in particular preferably 33 to 40% of the total pore volume of the smectite-silica gel mixed phase is accounted for by pores which have a pore diameter of less than 140 Å.

Furthermore, preferably at least 10%, particularly preferably at least 13% and in particular preferably 15 to 20% of the total pore volume of the smectite-silica gel mixed phase is accounted for by pores which have a pore diameter of 75 to 150 Å.

According to a further preferred embodiment less than 40%, preferably less than 35%, in particular preferably 25 to 33% of the total pore volume of the smectite-silica gel mixed phase is accounted for by pores which have a pore diameter of 250 to 800 Å.

According to a further preferred embodiment at least 12%, preferably at least 14%, particularly preferably 14 to 20% of the total pore volume is accounted for by pores which have a pore diameter of less than 75 Å.

According to a further embodiment preferably less than 80%, particularly preferably less than 75%, in particular preferably 60 to 70% of the total pore of the smectite-silica gel mixed phase is accounted for by pores which have a pore diameter of more than 140 Å.

According to a further preferred embodiment less than 60%, particularly preferably less than 50%, particularly preferably 40 to 45% of the total pore of the smectite-silica gel mixed phase is accounted for by pores which have a pore diameter of at least 250 Å.

Preferred proportions of total pore volume relative to pore diameter are listed in Table 1 below.

TABLE 1
Preferred percentage proportions of pore volume
accounted for by pores with a specific pore diameter in a
smectite-silica gel mixed phase which is used as adsorbent
in a first embodiment of the method according to aspects of
the invention.

| | | | Particularly | In particular |
|---|---|---|---|---|
| Pore diameter | | Preferred | preferred | preferred |
| 0-75 | Å | >12% | >14% | 15-20% |
| 75-140 | Å | >10% | >13% | 15-20% |
| 140-250 | Å | >15% | >20% | 21-25% |
| 250-800 | Å | <40% | <35% | 25-33% |
| >800 | Å | <20% | <15% | 10-14% |

In a second embodiment of the method according to aspects of the invention a smectite-silica gel mixed phase in which preferably at least 20%, particularly preferably at least 22% of the pore volume, in particular preferably 20 to 30% of the pore volume is accounted for by pores which have a diameter of less than 75 Å is used as adsorbent.

Furthermore, preferably at least 45%, particularly preferably at least 50% of the total pore volume of the smectite-silica gel mixed phase is accounted for by pores which have a pore diameter of less than 140 Å.

Furthermore, preferably less than 40%, particularly preferably less than 35% of the total pore volume is accounted for by pores which have a pore diameter of more than 250 Å. The smectite-silica gel mixed phase used in the second embodiment of the method according to aspects of the invention has only a small proportion of large pores. However, glycosides present in the biodiesel can still be removed within a period of time which is suitable for an industrial application.

Preferred proportions of the total pore volume accounted for by pores with specific diameters are listed in Table 2, wherein the adsorbent corresponds to an adsorbent such as is used in a second embodiment of the method according to aspects of the invention.

TABLE 2
Preferred percentage proportions of pore volume
accounted for by pores with a specific pore diameter in a
smectite-silica gel mixed phase which is used as adsorbent
in a second embodiment of the method according to aspects
of the invention.

| | | | Particularly |
|---|---|---|---|
| Pore diameter | | Preferred proportion | preferred proportion |
| 0-250 | Å | >55% | 60-80% |
| 0-800 | Å | <90% | 70-85% |
| >800 | Å | <30% | 10-25% |
| 75-140 | Å | <40% | 20-35% |
| 140-250 | Å | <25% | 10-20% |
| 250-800 | Å | <20% | 5-20% |
| 75-800 | Å | <65% | 50-60% |
| >75 | Å | <85% | 60-80% |
| >140 | Å | <60% | 30-50% |
| >250 | Å | <40% | 25-35% |

The method according to aspects of the invention is suitable for removing glycosides from biodiesel. As already explained, the method is suitable in particular for the post-purification of already purified biodiesel. Very small quantities of glycosides can also be removed from the biodiesel with the method according to aspects of the invention. Thus a biodiesel very pure in itself already is subjected to a post-purification in this embodiment. According to a preferred embodiment the crude biodiesel therefore has a glycoside content of less than 5000 ppmw, particularly preferably less than 2000 ppmw, in particular preferably less than 500 ppmw. The method according to aspects of the invention is suitable in particular for the removal of very small quantities of glycosides, in particular sterylglycosides. According to a preferred embodiment the crude biodiesel therefore has a glycoside content of less than 100 ppmw, further preferably less than 80 ppmw, in particular preferably less than 50 ppmw. According to an embodiment the crude biodiesel has a glycoside content of more than 10 ppmw, according to a further embodiment of more than 20 ppmw.

By glycosides are meant general compounds of carbohydrates and aglycones. Both mono- and also oligosaccharides can occur as carbohydrates. All compounds which can react with the carbohydrate accompanied by formation of glycosidic bond can in themselves act as aglycones. The aglycone can be bound both ^{˜}.and ^{˜}.glycosidically. Both aldoses and also ketoses which may be present both as 5- or 6-rings, thus as furanosides or pyranosides, can occur as carbohydrates.

The method according to aspects of the invention is suitable in particular for separating sterylglycosides from crude biodiesel. Sterylglycosides are glycosides which contain sterines as aglycone. As already explained in the introduction, sterines are nitrogen-free, polycyclic, hydroaromatic compounds, in particular derivatives of gonane or of perhydro-1H-cyclopenta[ ]phenatrene. Examples of sterylglycosides are sitosteryl, stigmasterol or campesterol-β-glycoside. Preferably the sterylglycosides are present in the form of a glycoside.

The glycosides, in particular sterylglycosides, are preferably present in non-acylated form. Because of the polar hydroxy groups of the saccharide the glycosides, in particular sterylglycosides, are very poorly soluble in biodiesel. They therefore very readily form a difficultly soluble precipitate in the biodiesel. As already explained, the method according to aspects of the invention is in particular suitable for the purification of biodiesel which still contains small impurities due to glycosides, in particular sterylglycosides. These are present as a very fine precipitate.

According to an embodiment of the method the crude biodiesel therefore comprises the at least one glycoside, in particular sterylglycoside, in the form of a fine-particulate precipitate, wherein the average particle size of the precipitate (D₅₀) is less than 200 μm, preferably less than 150 μm. The particle size of the precipitate preferably lies in the range of from 10 to 100 μm, particularly preferably in the range of from 10 to 20 μm. The average particle size is determined at room temperature (20° C.) for example by laser diffraction.

The glycoside, in particular sterylglycoside, precipitates in the form of crystal agglomerates, wherein, when observed under a microscope, the agglomerates display an amorphous structure of crystallites loosely connected gel-like to one another. These agglomerates in most cases do not consist of pure glycoside, in particular sterylglycoside, but still contain fatty acid esters which are adsorbed on the precipitate.

In order to be able to easily separate the adsorbent from the purified biodiesel, according to a preferred embodiment the adsorbent is provided in the form of a granular material. A powder is suitable in particular if the adsorbent is stirred into the crude biodiesel, thus, in the form of a suspension. A granular material is suitable in particular if the adsorbent is provided in the form of a column or a cartridge.

The particle size of the powder is generally set such that the adsorbent can be separated off from the biodiesel without difficulty with a suitable method, such as for example filtration, within a suitable period of time. If a powder suspended in the crude biodiesel is used, the dry sieve residue of the adsorbent on a sieve with a mesh size of 63 μm is preferably more than 25 wt.-% and lies preferably in a range of from 30 to 50 wt.-% and the dry sieve residue on a sieve with a mesh size of 25 μm is preferably more than 80 wt.-% and lies preferably in a range of from 85 to 98 wt.-%. Furthermore the dry sieve residue on a sieve with a mesh width of 45 μm is preferably more than 35 wt.-%, particularly preferably more than 45 wt.-%.

However, higher particle sizes are also suitable in particular for an application of the adsorbent in the form of a column packing. For this, the adsorbent is used preferably in the form of a granular material. Preferably a granular material which has a particle size of more than 0.1 mm is used for the production of column packings. Preferably the granular material has a particle size in the range of from 0.2 to 5 mm, in particular preferably 0.3 to 2 mm. The particle size can be set for example by sieving.

The granular material can be produced according to customary methods by for example exposing the finely-ground adsorbent to the action of a granulating agent, for example water, then granulating it a customary granulation device in a mechanically produced fluidized bed. However, other methods can also be used to produce the granular material. Thus the powdery adsorbent can for example be shaped into a granular material by compacting.

According to a preferred embodiment the granular material can be provided by air-drying, breaking and sieving the adsorbent. The granular material produced with this method is strong enough not to decompose into a fine powder when the crude biodiesel is treated. In order to improve the stability of the granular material produced in this manner, the granular material can also be subjected to further high-temperature treatment. For this, the granular material is preferably heated for at least 30 minutes, preferably at least 45 minutes, and particularly preferably for a period in the range of from 1 to 2 hours to a temperature of preferably at least 500° C., preferably at least 600° C. and particularly preferably to a temperature in the range of from 650° C. to 800° C. Scarcely any of the properties of the granular material are changed by the heat treatment.

As already explained, the adsorbent can be added direct to the crude biodiesel, wherein the biodiesel is preferably stirred. The chosen quantity of the adsorbent is preferably in a range of from 0.05 to 5 wt.-%, particularly preferably 0.1 to 2 wt.-%. The percentages relate to the weight of the crude biodiesel.

According to a preferred embodiment the adsorbent is provided in a column packing. The crude biodiesel can then be passed through the column packing. The column packing can be provided for example in the form of a cartridge. When carried out in practice, the crude biodiesel can then be passed through the cartridge until the adsorption capacity of the adsorbent contained in the cartridge is exhausted. The cartridge can then be exchanged for a new cartridge. The glycoside concentrated in the cartridge can then for example be recovered.

If the adsorbent is provided in the form of a column packing, the adsorbent is preferably provided in the form of larger particles in order to prevent a disproportionate pressure drop over the column packing.

Preferably, therefore, the adsorbent is used in the form of a granular material which has a particle diameter of more than 0.5 mm, in particular preferably a particle diameter in the range of from 1 to 5 mm. As already explained, such a granular material can be very easily produced by air-drying the smectite-silica gel mixed phase, either directly after extraction from a mine or optionally after a purification step to separate off at least a proportion of the minor minerals and then breaking it. The granular material of the desired particle size is then separated off by sieving. Optionally, the thus-produced particles of granular material can also be heat-treated in order to increase their stability.

In order to prevent the column from becoming clogged the crude biodiesel is preferably heated to a temperature above room temperature.

The use of the adsorbent in the form of a column also makes possible a regeneration of the column, e.g. with solvents, whereby the column packing can be used repeatedly. Suitable regenerants are for example mixtures of alcohols and alkanes or chlorinated hydrocarbons. Optionally, the regeneration can also be carried out with a gradient, wherein firstly the biodiesel is washed out of the column with a relatively non-polar solvent and a switch is then made to a more polar solvent, for example an alcohol, such as methanol or ethanol in order to elute the impurities bound to the adsorbent, in particular sterylglycosides, from the column.

The smectite-silica gel mixed phase used in the method according to aspects of the invention preferably reacts neutral to slightly alkaline. A suspension of 10 wt.-% of the adsorbent in water preferably has a pH in the range of from 5.5 to 9.0, particularly preferably 5.9 to 8.7 and in particular preferably in the range of from 7.0 to 8.5. The pH is determined using a pH electrode according to DIN ISO 7879.

The invention is described in further detail below with reference to examples.

The physical properties of the adsorbent were determined using the following methods:

BET Surface Area/Pore Volume According to BJH and BET:

The surface area and the pore volume were determined with a fully automatic Micromeritics ASAP 2010 type nitrogen porosimeter.

The sample is cooled in high vacuum to the temperature of liquid nitrogen. Nitrogen is then continuously dispensed into the sample chambers. An adsorption isotherm is calculated at constant temperature by recording the adsorbed quantity of gas as a function of the pressure. The analysis gas is progressively removed and a desorption isotherm recorded in a pressure equalization.

To ascertain the specific surface area and the porosity according to the BET theory, the data are evaluated according to DIN 66131.

The pore volume is furthermore calculated from the measurement data applying the BJH method (E. P. Barret, L. G. Joiner, P. P. Halenda, J. Am. Chem. Soc. 73 1991, 373). Capillary condensation effects are also taken into account with this method. Pore volumes of specific volume size ranges are determined by totalling incremental pore volumes obtained from the evaluation of the adsorption isotherm according to BJH. The total pore volume according to the BJH method relates to pores with a diameter of from 1.7 to 300 nm.

Water Content:

The water content of the products at 105° C. is ascertained using the DIN/ISO-787/2 method.

Silicate Analysis:

(a) Sample Decomposition

This analysis is based on the total decomposition of the crude clay or corresponding product. After the dissolution of the solids, the individual components are analyzed using conventional specific analysis methods, such as e.g. ICP, and quantified.

For the sample decomposition, approx. 10 g of the sample to be examined is finely ground and dried for 2-3 hours in the drying cupboard at 105° C. until the weight is constant. Approx. 1.4 g of the dried sample is placed in a platinum crucible and the weighed-in sample measured to within 0.001 g. The sample is then mixed in the platinum crucible with 4-6 times the quantity by weight of a mixture of sodium carbonate and potassium carbonate (1:1). The mixture is placed in a Simon-Muller oven with the platinum crucible and melted for 2-3 hours at 800-850° C. The platinum crucible with the melt is removed from the furnace with a platinum collet and left to cool. The cooled melt is flushed into a casserole with a little distilled water and concentrated hydrochloric acid is carefully added to it. After gas has stopped forming the solution is evaporated until dry. The residue is taken up again in 20 ml conc. hydrochloric acid and again evaporated until dry. Vaporization with hydrochloric acid is repeated once more. The residue is moistened with approx. 5-10 ml hydrochloric acid (12%), has approx. 100 ml dist. water added to it and is heated. Insoluble SiO₂ is filtered off, the residue washed three times with hot hydrochloric acid (12%) and then washed with hot water (dist.) until the filtrate water is chloride-free.

(b) Silicate Determination

The SiO₂ is burned off with the filter and weighed out.

(c) Determining Aluminium, Iron, Calcium and Magnesium

The filtrate collected during silicate determination is transferred into a 500-ml measuring flask and made up with water to the calibration mark. Aluminium, iron, calcium and magnesium determination is then carried out from this solution by means of FAAS.

(d) Determining Potassium, Sodium and Lithium

500 mg of the dried sample is weighed accurate to within 0.1 mg into a platinum dish. The sample is then thoroughly moistened with approx. 1-2 ml dist. water and 4 drops concentrated sulphuric acid is added. This is then vaporized three times with approx. 10-20 ml conc. HF in the sand bath until dryness is achieved. Finally, it is moistened with H₂SO₄ and fumed off on the furnace plate until dryness is achieved. After brief annealing of the platinum dish approx. 40 ml dist. water and 5 ml hydrochloric acid (18%) is added and the mixture boiled up. The obtained solution is transferred into a 250-ml measuring flask and made up to the calibration mark with dist. water. Sodium, potassium and lithium contents are ascertained from this solution by means of EAS.

Loss on Ignition:

In an annealed weighed porcelain crucible with a cap approx. 1 g dried sample is weighed in accurate to within 0.1 mg and annealed for 2 h at 1000° C. in the muffle furnace. The crucible is then cooled in the desiccator and weighed out.

Ion Exchange Capacity:

To determine the cation exchange capacity, the clay material to be examined is dried over a period of 2 hours at 105° C. The dried clay material is then reacted with an excess of aqueous 2N NH₄Cl solution for 1 hour accompanied by reflux. After standing for 16 hours at room temperature, the mixture is filtered, whereupon the filter cake is washed, dried and ground and the NH₄ content in the clay material is ascertained by nitrogen determination (“Vario EL III” CHN analyzer from Elementar, Hanau) in accordance with the manufacturer's instructions. The proportion and type of the exchanged metal ions are determined in the filtrate by ICP spectroscopy.

Determining the Sediment Volume:

A graduated 100-ml measuring cylinder is filled with 100 ml distilled water. 2 g of the substance to be added is slowly and portionwise passed to the surface of the water with a spatula at the rate of approximately 0.1 to 0.2 g a time. After an added portion has settled the next portion is added. After the 2 g of substance has been added and fallen to the bottom of the measuring cylinder the cylinder is left to stand for one hour at room temperature. The level of the sediment volume in ml/2 g is then read off from the scale on the measuring cylinder. To determine the sediment volume after 3 days' storage in water the sample batch is sealed with Parafilm® and left to stand vibration-free for 3 days at room temperature. The sediment volume is then read off from the scale on the measuring cylinder.

Determining the Montmorillonite Content Via Methylene Blue Adsorption

The methylene blue value is a measure of the internal surface area of the clay materials.
a) Producing a tetrasodium diphosphate solution
5.41 g tetrasodium diphosphate is weighed out accurate to within 0.001 g into a 1000-ml measuring flask and, accompanied by shaking, made up to the calibration mark with dist. water.
b) Producing a 0.5% methylene blue solution
125 g methylene blue is dissolved in approx. 1500 ml dist. water in a 2000-ml beaker. The solution is decanted and made up to 25 l with dist. water.
0.5 g moist test-grade bentonite with a known internal surface area is weighed out accurate to within 0.001 g in an Erlenmeyer flask. 50 ml tetrasodium diphosphate solution is added and the mixture is heated to boiling for 5 minutes. After cooling to room temperature, 10 ml 0.5 molar H₂SO₄ is added and 80 to 95% of the expected final consumption of methylene blue solution is added. A drop of the suspension is taken up with the glass rod and placed onto a filter paper. A blue-black stain with a colourless corona forms. Further methylene blue solution is now added in portions of 1 ml and the spot test repeated. Solution continues to be added until the corona turns slightly light blue, i.e. the added quantity of methylene blue is no longer absorbed by the test bentonite.
c) Testing of clay materials
The clay material is tested in the same manner as for the test bentonite. The internal surface area of the clay material can be calculated from the consumed quantity of methylene blue solution.
381 mg methylene blue/g clay corresponds according to this method to a 100% montmorillonite content.

Determining the Dry Sieve Residue

Approximately 50 g of the air-dry clay material to be examined is weighed out on a sieve of the appropriate mesh size. The sieve is connected to a vacuum cleaner which sucks out through the sieve via a suction slit rotating beneath the sieve bottom all of the portions which are finer than the sieve. The sieve is covered with a plastic lid and the vacuum cleaner is switched on. After 5 minutes, the vacuum cleaner is switched off and the quantity of coarser portions remaining on the sieve is ascertained by differential weighing.

Determining the Wet Sieve Residue

Firstly a 5% suspension is produced by stirring a corresponding quantity of the clay material to be examined into water at approx. 930 rpm for approx. 5 minutes. The suspension is stirred for a further 15 minutes at approx. 1865 rpm and the suspension then poured through a sieve of the desired mesh size. The residue is washed with tap water until the washing water runs off clear. The sieve with the residue is then placed in an ultrasound bath for 5 minutes in order to remove residual fines. The remaining residue is washed briefly with tap water and the ultrasound treatment optionally repeated until fines no longer pass into the water during the ultrasound treatment. The sieve is then dried until the weight is constant. For weighing-out the residue remaining on the sieve is transferred into a weighed porcelain dish.

Determining the Bulk Density

A measurement cylinder cut off at the 1000-ml mark is weighed. The sample to be examined is then poured, by means of a powder funnel, into the measuring cylinder in one go such that a wedge-shaped bulk material forms above the end of the measuring cylinder. The bulk mass is wiped off with the help of a ruler which is guided across the opening of the measuring cylinder, and the filled measuring cylinder weighed again. The difference corresponds to the bulk density.

X-Ray Diffractometry

1 to 2 g of the sample is ground by hand in an agate mortar and then sieved through a sieve with a mesh width of 20 μm. The grinding process is optionally repeated until the whole sample passes through the sieve. A Siemens D5000 X-ray diffractometer was used for the measurements. The following measurement conditions were used:

| | |
|---|---|
| Sample holder: | Plastic, “top loading”, Ø = 25 mm |
| Thickness of the | 1 mm |
| powder layer: | |
| X-ray source | Cu Kα: 40 kV/40 mA |
| Diffraction angle | 2-80° (2θ) |
| Measurement time | 3 seconds per step |
| Gap | Primary and secondary divergence baffles |
| | with slit widths of 1 mm |

The qualitative evaluation of the diffractograms, i.e. the allocation of the mineral phases, took place with the help of the commercially available “EVA” programme from Bruker AXS GmbH, Karlsruhe corresponding to the publication by Brindley and Brown (1980): “Crystal Structures of clay minerals and their X-ray identification”; Mineralogical Society No. 5, 495.

The quantitative evaluation took place according to the Rietveld method using the AutoQuan computer program from Seifert GE Inspection Technologies GmbH, Ahrensburg, DE. To determine the proportion of the amorphous phase, zincite was used as internal standard. A fourth-degree polynomial in an angle range of from 4 to 80° (2θ) was used for background adjustment.

X-Ray Diffractometry to Determine the Minor Mineral Content of the Comparison Sample (Calcium Bentonite)

The X-ray photographs for this sample were taken on a high-resolution Phillips powder diffractometer (X′-Pert-MPD(PW 3040)) which was equipped with a Cu anode. The minor mineral content of the sheet silicate (e.g. bentonite) was determined by comparison with measurements from a series of concentrations with accessory-mineral-free sheet silicate which was enriched with the corresponding minor mineral. For this, so-called NIST standards NIST (obtained from the National Institute of Standards and Technology, 100 Bureau Drive, Stop 2300, Gaithersburg, Md. 20899-2300) were used for the minerals. The reflex intensity (level) of the most intensive reflex as a function of the level of the minor mineral in question in the reference material was determined for each mineral. After determining the level of the same reflex in the unknown sample, the level of the corresponding minor mineral can be calculated from these data. This method is to be considered semi-quantitative.

Determining the Sterylglycosides with HPLC:

A GC-MS method developed by ASG Analytik-Service Gesellschaft mbH, Trentiner Ring 30, 86356 Neusäβ was used for determining the sterylglycosides. The procedure was as follows:

1. Enriching the Sterylglycosides

To enrich the sterylglycosides a defined quantity of the crude biodiesel to be examined was filtered through a 1.6 μm glass-fibre filter according to the IP 387/97 Filter Blocking Tendency (FBT) test. Approx. 300 mL biodiesel is required for a complete test.

The filter was then firstly extracted with 4 mL hexane and the sterylglycosides then washed out of the filter with 1 ml pyridine. 100 μL MSTFA (N-methyl-N-(trimethylsilyl) trifluoroacetamide) as silylation reagent and 50 μL tricaprine solution (71.3 mg tricaprine on 10 mL pyridine) was added to the sample. The mixture was left to stand for 20 min at 60° C. and 7 mL hexane then added. The mixture was filtered over a 0.45 μm injection filter. In each case 1 μL of the solution was injected into the GC/MS system for the measurements.

2. Calibration Standards

The quantification of the sterylglycosides took place by comparison with a calibration curve.

For this, a parent solution of a pure sterylglycoside mixture in pyridine was produced, the concentration of which was set in the range of from approx. 50 mg/10 mL. Defined volumes of the parent solution were measured off and 100 μL MSTFA as well as 50 μL tricaprine solution added. The mixture was left to stand for 20 minutes at 60° C. and filtered through a 0.45 μm injection filter after the addition of 8 mL hexane. In each case 1 μL of the solution was injected into the GC/MS system for the measurements. A calibration curve was produced from the intensities of the MS signals depending on the injected sample quantity.

3. GC/MS Measurement

3.1 GC Conditions
Precolumn: Zebron Guard Column; 10 m; 0.32 mm ID
Column: Zebron-5HT Inferno; 15 m; 0.32 mm ID; 0.25 μm
Injection: on column
Carrier gas: helium
Flow: 1.5 ml/min
Oven: 60° C. for 1 min, heated at 15° C./min to 375° C., temperature held for 3 min.

3.2 MS Conditions
Segment 1: 0-2 min hexane, cut-off
Segment 2: 2-25 min EI (auto), 40-650 m/z
Scan time: 0.50 scans/sec
Multiplier Offset: 0 V
Emission current: 40 μA
Count threshold: 1 counts
Target TIC: 10000 counts
Prescan ionization time: 100 μsec
Max. ionization time: 5000 μsec
Background mass: 50 m/z
RF dump value: 650 m/z

4. Evaluation

The quantity of sterylglycosides contained in the samples was ascertained by comparing the intensity of the MS signals with the calibration curve.

Purification of Biodiesel

Starting Material

Adsorbents Used:

The adsorbents listed in Table 3 were used for the tests. In addition to the adsorbents 1 to 3 used according to aspects of the invention, another commercially available calcium bentonite (Calcigel®, Süd-Chemie AG, Munich, DE), as well as a commercially available synthetic magnesium silicate (Magnesol®, The Dallas Corp., Dallas, US) was used as comparison.

The physical data for the adsorbents 1 to 3 used according to aspects of the invention, as well as those for the commercially used calcium bentonite, are listed in Table 3.

TABLE 3
Physical properties of adsorbents

| | Adsorbent | | | |
|---|---|---|---|---|
| | | | | Ca |
| | 1 | 2 | 3 | bentonite |
| Dry sieve residue on 45 μm (%) | 49 | 55 | 5.2 | n.d. |
| Dry sieve residue on 63 μm (%) | 35 | 40 | 38 | max. 20 |
| Bulk density (g/l) | 292 | 468 | — | 750 |
| Methylene blue adsorption | 106 | 152 | 179 | 247 |
| (mg/g sample) | | | | |
| Water content (%) | 8 | 13 | 12 | 9 ± 4 |
| pH (10 wt.-% in water) | 7.6 | 9 | 8.1 | |
| Cation exchange capacity | 52 | 44 | 53.3 | 59 |
| (meq/100 g) | | | | |
| BET surface area (m²/g) | 208.4 | 238 | 248 | 65 |
| Cumulative pore volume (BJH) | 0.825 | 0.623 | 0.777 | 0.103 |
| for pore diameters 1.7-300 nm | | | | |
| (cm³/g) | | | | |
| Average pore diameter | 16.4 | 10.0 | 55 | 9.6 |
| (BJH) (nm) | | | | |
| Sediment or swelling volume | 5.5 | 3 | 4 | 6 |
| (ml/2 g) | | | | |

The composition of the adsorbents 1 to 3 used according to aspects of the invention as well as that of the calcium bentonite used as comparison is given in Table 4.

TABLE 4
Composition of the adsorbents

Adsorbent

| | | | | Calcium |
|---|---|---|---|---|
| | 1 | 2 | 3 | bentonite |
| SiO₂ | 70.6 | 69.4 | 69.4 | 57.9 |
| Fe₂O₃ | 2.8 | 3.4 | 3.4 | 4.9 |
| Al₂O₃ | 9.8 | 9.9 | 9.9 | 18.3 |
| MgO | 4.1 | 3.1 | 3.1 | 3.4 |
| CaO | 1.4 | 2.5 | 2.5 | 3.1 |
| K₂O | 1.5 | 1.3 | 1.3 | 1.8 |
| Na₂O | 0.26 | 0.94 | 0.94 | 0.7 |
| TiO₂ | 0.25 | 0.38 | 0.38 | — |
| SO₃ | — | — | — | — |
| LOI (1000° C.) | 7.9 | 8.1 | 8.1 | 8.9 |

Furthermore, the mineral composition of the adsorbents 1 and 2 used according to aspects of the invention was examined more closely using X-ray diffractometry. The evaluation took place as described above. The mineral composition of the adsorbents 1 and 2 as well as of the calcium bentonite used as comparison is listed in Tables 5a and 5b.

TABLE 5a
Mineral composition of adsorbents, ascertained by
evaluation of X-ray diffractograms using Rietveld analysis

| Mineral phase | Adsorbent 1 | Adsorbent 2 |
|---|---|---|
| Smectite (wt.-%) | 40 | 40 |
| Illite/muscovite (wt.-%) | Traces | n.d. |
| Kaolinite (wt.-%) | n.d. | 1 |
| Sepiolite (wt.-%) | 11 | n.d. |
| Quartz (wt.-%) | Traces | 1 |
| Orthoclase (wt.-%) | 12 | 8 |
| Plagioclase (various) (wt.- | 3 | 11 |
| %) | | |
| Calcite (wt.-%) | Traces | 1 |
| Amorphous material (wt.-%) | 34 | 38 |

The minor mineral levels in the calcium bentonite used as comparison material, determined from X-ray measurements, are listed in Table 5b below (see method description):

TABLE 5b
Mineral composition of the calcium bentonite
(Calcigel ®) used as comparison

| | Calcium |
|---|---|
| Mineral phase | bentonite |
| Kaolinite (wt.-%) | 1-2 |
| Quartz (wt.-%) | 6-9 |
| Feldspar (wt.-%) | 1-4 |
| Mica (wt.-%) | 1-6 |
| Other minerals (wt.-%) | 5-10 |

The adsorbents 1 and 2 contain smectite as well as an amorphous phase as essential constituents. Additionally, the clay minerals used as adsorbents also contain proportions of minor minerals. Thus adsorbent 1 also contains proportions of sepiolite and orthoclase, as well as smaller amounts of plagioclase. Adsorbent 2 contains as essential minor minerals plagioclase and sepiolite as well as smaller proportions of kaolinite, quartz and calcite. Both adsorbents contain more than 30% amorphous phase. Adsorbent 2 contains the amorphous phase in almost the same quantity as the smectitic clay (ratio 100:95). For adsorbent 1 the ratio of smectitic clay to amorphous material is 100:85. The clay minerals used in the method according to aspects of the invention therefore have a completely different structure from smectitic clays such as have been used hitherto, for example to whiten oils. The high proportion of amorphous material is formed by amorphous, natural silica gel. This is shown by joint consideration of the silicate analysis which displays a high SiO₂ content for the two adsorbents 1 and 2. High SiO₂ contents are usually found in bentonite or smectite samples only if these minerals contain large quantities of minor minerals, such as quartz, cristobalite or tridymite.

Producing Granular Materials

Crude clays which correspond to the adsorbents 1 and 2 were dried in air at a water content of from 50 to 60 wt.-% to a water content of from 6 to 8 wt.-%. The dried crude clays were comminuted in a jaw crusher and granular materials with a range of sizes of from 0.2 to 1.2 or from 0.2 to 1.0 mm were then separated off by sieving. The properties of the thus-obtained granular materials are listed in Table 6.

TABLE 6
Properties of granular adsorbents

| | Adsorbent 1 in | Adsorbent 2 in |
|---|---|---|
| | granular form | granular form |
| Water content (%) | 8.5 | 6 |
| pH (2 wt.-% in water) | 8 | 8 |
| Bulk density (g/l) | 340 | 630 |
| Particle size distribution | 5% max. > 1.2 mm | 5% max. > 1 mm |
| | 5% max. < 0.2 mm | 5% max. < 0.2 mm |

In each case, the adsorbents were dried to a water content<8 wt.-% in a drying cupboard before the examples were carried out.

Crude Biodiesel

Biodiesel from Palm Oil

A biodiesel (methyl ester) which had been produced from palm oil was used for the tests described below. A sterylglycoside content of 11 ppm was able to be established by means of GC/MS in the starting sample. At room temperature the sterylglycosides are visible in the form of clouding which is caused by small crystals and flakes. This clouding disappears if the sample is heated to 80° C. After cooling, these precipitate again, i.e. the process is reversible. Experience shows that this applies only if the water content of the biodiesel is low. This crude biodiesel was used without further pretreatment in the following examples.

Biodiesel from Soya Oil

A biodiesel (methyl ester) produced from soya oil was used for further examples. The crude biodiesel contained 28 ppm sterylglycosides.

Purifying Procedure

Accompanied by stirring, 1 wt.-% adsorbent was added in each case to approximately 500 to 800 g of the crude biodiesel. The sample was stirred for 20 minutes at room temperature and the adsorbent then separated off by filtration through a paper filter. The filtrate was used directly to quantify the sterylglycosides.

### EXAMPLE 1

### Purification of Biodiesel Produced from Palm Oil by Suspending an Adsorbent in the Biodiesel

The crude biodiesel produced from palm oil was purified in the manner given above with the adsorbents characterized in Table 3. The quantities of sterylglycosides ascertained for the samples are listed in Table 7.

TABLE 7
Sterylglycosides contents in biodiesel samples produced from
palm oils and purified with different adsorbents

| Adsorbent | Sterylglycoside content (mg/Kg) |
|---|---|
| Crude biodiesel | 10 |
| Adsorbent 1 | n.d. |
| Calcium | 8 |
| bentonite | |
| Magnesol | n.d. |

n.d.: non-determinable; below the detection limit of the method

A purification performance comparable with the commercially available synthetic magnesium silicate Magnesol® was achieved with the adsorbent 1 used according to aspects of the invention. However, the purification performance of the adsorbent 1 is better compared with calcium bentonite. This shows that because of its high porosity the adsorbent 1 used according to aspects of the invention has an improved adsorption compared with a customary bentonite, although it may be presumed that in the case of the adsorbent 1, the surface areas of the bentonite structures are also responsible for the adsorption of the sterylglycosides.

### EXAMPLE 2

### Purification of Biodiesel Produced from Soya Oil

Analogously to Example 1 the adsorbent in question was suspended in the crude biodiesel. The adsorbents 1 and 2 characterized in Table 3 as well as the granular adsorbents 1 and 2 from Table 6 were used as adsorbents. The sterylglycosides levels ascertained after purification are listed in Table 8.

TABLE 8
Sterylglycosides contents in the biodiesel (soya
oil) after purification with different adsorbents

| | Sterylglycosides content |
|---|---|
| | (ppm) |
| Crude biodiesel, measurement 1 | 48 |
| Crude biodiesel, measurement 2 | 51 |
| Calcium bentonite (Calcigel ®) | 42 |
| Magnesium silicate (Magnesol ®) | <10 |
| Adsorbent 1; powder | <10 |
| Adsorbent 2; powder | <10 |
| Adsorbent 1; granular material | <10 |
| Adsorbent 2; granular material | <10 |

Both with powdery and with granular adsorbent 1 and 2 respectively the sterylglycosides content can be reduced to less than 10 ppm with the method according to aspects of the invention.

As the data show, it is possible to reduce the level of sterylglycosides in the biodiesel from 50 ppm (mean value of the measurements of untreated biodiesel) to below 10 ppm (detection limit of the method) with 1% of the adsorbents used according to aspects of the invention. The materials according to aspects of the invention are at least equivalent to the material Magnesol® already available on the market for the purification of biodiesel. It is surprising that fragmented granular materials have a similar effect to powder. On the other hand, customary bentonites, such as the calcium bentonite used as comparison, are less effective, although according to the literature bentonite surface areas have a high affinity for compounds with hydroxyl groups, in particular alcohols. Thus the swelling of bentonites with glycerol is used to detect their presence by X-ray measurements. In this case the sheets swell through the intercalation of the glycerol. The greater effectiveness of the materials according to aspects of the invention compared with the standard bentonites can be explained by their clearly higher porosity and their greater accessibility of the sheet silicate surface areas for an adsorption.

### EXAMPLE 3

### Purification of a Biodiesel Produced from Palm Oil by a Granular Adsorbent Packed in a Column

a) Air-Dried Granular Material

50 g of the granular adsorbent 1 described in Table 6 was poured into a glass column provided with a fritted glass filter and a Teflon valve which had an inner diameter of 3 cm. 5 l of a crude biodiesel (methyl ester) produced from palm oil which had a level of sterylglycosides of 50 ppm was added portionwise to the column. The crude biodiesel was tempered to approx. 60° C. in a water bath and passed portionwise into the space above the column packing such that the outflowing quantity of biodiesel was supplemented and an approximately uniform flow through the column packing was achieved. The flow rate of the column was set to approx. 50 ml/min by means of the Teflon valve. The purified biodiesel was poured collected in a glass vessel which was provided with a graduated scale. After approximately 2 l of crude biodiesel had been passed into the column, 50 ml of the purified biodiesel was collected and the sterylglycosides content in the sample determined with HPLC as described above. A residual sterylglycoside content of 8 ppm was determined.

After approx. 4.8 l crude biodiesel had passed through, a fresh 50-ml sample was collected and its sterylglycosides content examined. The sterylglycosides content was determined at approximately 50 ppm. The capacity of the column was thus considered to be exhausted.

b) Heat-Treated Granular Material

Approx. 300 g of the granular material 1 described in Table 6 was heated to 600° C. in a furnace for one hour. After cooling in air, a heat-treated granular material was obtained which, upon crushing, had a clearly higher strength compared with the air-treated granular material.

Analogously as described with the air-dried granular material, a column packing was produced and crude biodiesel passed over the column.

After approximately 2 l biodiesel had been passed into the column a sample was taken. The level of sterylglycosides in the sample was determined at 18 ppm. The activity of the adsorbent is thus slightly weakened by the high-temperature treatment.

c) Regeneration of the Column

A mixture of chloroform and methanol (2:1 v/v) was passed into the obtained exhausted column as described in (a) and 800 ml was eluted. Then the column was again charged with 3 l crude biodiesel as described in (a). After the column had been charged with 2.5 l crude biodiesel a 50-ml sample was collected. The HPLC analysis showed a sterylglycosides content of 11 ppm.

1. A method for purifying biodiesel, comprising the steps of:
(a) providing a crude biodiesel comprising at least one glycoside;
(b) reacting the crude biodiesel with an adsorbent that comprises at least one smectite-silica gel mixed phase, wherein the smectite-silica gel mixed phase has at least the following physical parameters:
(i) a specific surface area of more than 120 m²/g;
(ii) a total pore volume of more than 0.35 ml/g; and
(iii) a silicon content, calculated as SiO₂, of at least 60 wt-%; and
(c) separating off a purified biodiesel off from the adsorbent.

2. The method according to claim 1, wherein the crude biodiesel has a glycoside content of more than 10 ppm.

3. The method according to claim 1, wherein the ate least on glycoside comprises a sterylglycoside.

4. The method according to claim 1, wherein the adsorbent is in the form of a granular material.

5. The method according to claim 4, wherein the granular material has a particle size of more than 0.5 mm.

6. The method according to claim 4, wherein the granular material is obtained by air-drying, breaking and sieving the adsorbent.

7. The method according to claim 1, wherein the adsorbent is provided in the form of a column packing.

8. The method according to claim 1, wherein the smectite-silica gel mixed phase has an aluminium content, calculated as Al₂O₃, of less than 15 wt.-%.

9. The method according to claim 1, wherein the smectite-silica gel mixed phase has an amorphous-phase content, ascertained by quantitative X-ray diffraction analysis, of at least 10%.

10. The method according to claim 1, wherein the smectite-silica gel mixed phase a has a cation exchange capacity of more than 40 meq/100 g.

11. The method according to claim 1, wherein the glycoside is separated from the adsorbent after the separation of the purified biodiesel from the adsorbent.
